(19) United States
(12) Patent Application Publication
(10) Pub. No.: US 2005/0155390 A1
(43) Pub. Date: Jul. 21, 2005

(54) Apparatus for manufacturing porous glass preform for optical fiber

(75) Inventors: Katsubumi Nagasu, Sakura-shi (JP); Naritoshi Yamada, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIKURA LTD

(21) Appl. No.: 11/033,541

(22) Filed: Jan. 12, 2005

(30) Foreign Application Priority Data
Jan. 14, 2004 (JP) 2004-006632
Nov. 22, 2004 (JP) 2004-338049

(51) Int. Cl. C03B 37/018

(52) U.S. Cl. 65/531; 138/114; 138/148

(57) ABSTRACT

An apparatus for manufacturing a porous glass preform for an optical fiber includes a glass synthesizing burner, a gas source for supplying a glass forming gas to the glass synthesizing burner, and a piping for connecting the gas source to the glass synthesizing burner, in which the piping includes at least one layer made of flexible synthetic resin, wherein a ratio of a moisture permeability coefficient P (g·cm/cm²·s·cmHg) of the piping to a thickness L of the piping (cm) (P/L) is less than 1.0×10⁻¹⁰ g/cm²·s·cmHg.

### BACKGROUND OF THE INVENTION

1. Field of the Invention

The present invention relates to an apparatus for manufacturing a porous glass preform for an optical fiber.

Priority is claimed on Japanese Patent Application No. 2004-6632, filed Jan. 14, 2004, and Japanese Patent Application No. 2004-338049, filed Nov. 22, 2004, the contents of which are incorporated herein by reference.

2. Description of Related Art

An optical fiber preform may be manufactured after fabricating a porous glass preform using various methods, such as a VAD (Vapor-phase Axial Deposition) method or an OVD (Outside Vapor Deposition) method, and then dehydrating and sintering the resulting porous glass preform in an electric furnace to vitrify it. In the outside vapor deposition method, a glass forming gas, such as silicon tetrachloride (SiCl₄) or germanium tetrachloride (GeCl₄), is subjected to a hydrolysis or oxidation reaction with oxygen and hydrogen gases in a flame to synthesize glass particles. The resulting glass particles (soot) are deposited around the outer periphery of a cylindrical core preform that is made of glass. The cylindrical core preform, which becomes the core or the core and a part of the cladding of the resulting optical fiber, is rotated on its axis so that a porous layer consisting of multiple layers is formed.

When manufacturing a porous glass preform, an apparatus for manufacturing a porous glass preform is generally used, and such an apparatus includes a glass synthesizing burner that has a nozzle for jetting glass forming gas to a core preform, a gas source that includes a gas cylinder, a tank, or a vessel for providing the glass forming gas to the glass synthesizing burner, and a piping for connecting the gas source to the glass synthesizing burner.

In the apparatus for manufacturing a porous glass preform, the piping for supplying the glass forming gas from the gas source to the glass synthesizing burner is required to have acid resistance because the glass forming gas is acid. In addition, the piping is required to be heat resistant in cases when the glass forming gas is supplied while heating to about between 60° C. and 100° C.

In particular, in a porous glass preform manufacturing apparatus used for an outside vapor deposition method in which a glass synthesizing burner having a nozzle for jetting a glass forming gas to a core preform is shifted with respect to the core preform, the piping for supplying the glass forming gas is required to be bent according to the shift of the glass synthesizing burner. Therefore, a flexible piping made of a synthetic resin, for example, polytetrafluoroethylene or the like, is used (see Japanese Unexamined Patent Application, First Publication No. 2000-159532, for example).

Furthermore, even when the glass synthesizing burner is not shifted, the metal piping and the glass-made glass synthesizing burner cannot be directly connected, or when easier handling is desired, a piping made of a synthetic resin, such as polytetrafluoroethylene or the like, is used as a piping for supplying the glass forming gas.

When a piping made of a synthetic resin, such as polytetrafluoroethylene or the like, is used as a piping for supplying the glass forming gas for a long time, the piping may be hardened and its flexibility may be lost. Such a hardening of the piping occurs when moisture in the air permeates inside the piping and reacts with silicon tetrachloride, i.e., the glass forming gas, in the proximity to the inner wall of the piping to generate silicon dioxide, and the resulting silicon dioxide deposits on the surface of the inner wall of the piping. As the hardening of the piping progresses, a breach or cracking may occur in the piping and the glass forming gas may leak therefrom.

Furthermore, in a glass preform manufacturing apparatus in which a glass synthesizing burner is shifted back and forth in the longitudinal direction of the core preform, a piping connected to the glass synthesizing burner is more susceptible to a breach or cracking since the piping is bent or extended repeatedly in accordance with the shift of the glass synthesizing burner.

In recent years, outside vapor deposition methods have required that the longitudinal movement of the movable glass synthesizing burner be increased. The increased motion of the glass synthesizing burner results in the supply line being bend more time. Thus causes a more rapid deterioration of the piping. The more piping becomes susceptible to a breach or cracking, the more often replacement of the piping is required, which may cause various problems, such as the corrosion of the entire apparatus due to leakage of the glass forming gas from such a breach or crack, in addition to an increased production cost.

Furthermore, silicon dioxide generated within the piping causes bubbles or foreign objects in a preform when it peels off, which contributes to deterioration of the quality of a preform.

Furthermore, Japanese Unexamined Patent Application, First Publication No. 2000-159532 discloses a feedstock supply tube made of polytetrafluoroethylene, although no published patent document claims tubing using a synthetic resin, such as polytetrafluoroethylene or the like.

### SUMMARY OF THE INVENTION

The present invention was made in view of the above background, and an object thereof is to provide an apparatus for manufacturing a porous glass preform for an optical fiber that has an excellent durability for a long period.

In order to solve the problems mentioned above, the present invention is directed to an apparatus for manufacturing a porous glass preform for an optical fiber including a glass synthesizing burner, a gas source for supplying a glass forming gas to the glass synthesizing burner, and a piping for connecting the gas source to the glass synthesizing burner, in which the piping includes at least one layer made of flexible synthetic resin, wherein a ratio of a moisture permeability coefficient P (g·cm/cm²·s·cmHg) of the piping to a thickness L of the piping (cm) (P/L) is less than 1.0×10⁻¹⁰ g/cm²·s·cmHg.

In the apparatus for manufacturing a porous glass preform for an optical fiber according to the present invention, the piping may include at least two layers, and at least one layer of the at least two layers may be made of one of stainless steel and aluminum.

In the apparatus for manufacturing a porous glass preform for an optical fiber according to the present invention, the piping may include an inner piping for supplying the glass forming gas and an outer piping that is provided around an outer periphery of the inner piping while being spaced by a gap, and a dry gas may be supplied through the gap.

In the apparatus for manufacturing a porous glass preform for an optical fiber according to the present invention, the gas supplied through the gap may contain at least one gas selected from the group consisting of nitrogen, argon, and helium.

In the apparatus for manufacturing a porous glass preform for an optical fiber according to the present invention, the outer piping may be made of polytetrafluoroethylene.

In the apparatus for manufacturing a porous glass preform for an optical fiber according to the present invention, the piping may be covered by a heater and a thermal insulating material.

In the apparatus for manufacturing a porous glass preform for an optical fiber according to the present invention, the synthetic resin may be at least one member selected from the group consisting of Nylon 11, Nylon 12, polyurethane, polyvinyl chloride, and fluorine resins.

In the apparatus for manufacturing a porous glass preform for an optical fiber according to the present invention, the piping may include an inner layer and an outer layer.

In the apparatus for manufacturing a porous glass preform for an optical fiber according to the present invention, the inner layer may be made of a synthetic resin and the outer layer may be made from a material having a small moisture permeability coefficient P.

In the apparatus for manufacturing a porous glass preform for an optical fiber according to the present invention, the material having a small moisture permeability coefficient P may be one member selected from the group consisting of stainless steel, aluminum, copper, nickel, and iron.

In the apparatus for manufacturing a porous glass preform for an optical fiber according to the present invention, the inner layer may be made of polytetrafluoroethylene and the outer layer may be made of stainless steel.

In the apparatus for manufacturing a porous glass preform for an optical fiber according to the present invention, the inner layer may have a thickness between 0.3 mm and 2.0 mm and the outer layer may have a thickness of between 0.01 mm and 0.20 mm.

According to the apparatus for manufacturing a porous glass preform for an optical fiber of the present invention, since the ratio of a moisture permeability coefficient (P) (g·cm/cm²·s·cmHg) of the piping to a thickness L of the piping (cm) (P/L) is less than 1.0×10⁻¹⁰ in the piping for supplying the glass forming gas from the gas source to the glass synthesizing burner, permeation of moisture in the air into the piping and generation of silicon dioxide by a reaction between the moisture and silicon tetrachloride are reduced. Accordingly, the progress of the hardening of the piping is delayed, and the lifetime of the piping is extended. Furthermore, since the piping includes the at least one layer made of flexible synthetic resin, the damage to the piping, such as breakage, can be prevented because the piping can be bent in accordance with the shift of the glass synthesizing burner when the glass synthesizing burner is shifted in the longitudinal direction of the core preform.

### BRIEF DESCRIPTION OF THE DRAWINGS

FIG. 1 is a schematic diagram of an apparatus for manufacturing a porous glass preform for an optical fiber by the OVD method as an embodiment of the present invention;

FIG. 2 is a schematic cross-sectional view illustrating one example of a piping that connects the gas source to the glass synthesizing burner employed in the apparatus for manufacturing a porous glass preform for an optical fiber of the present invention;

FIG. 3 is a graph indicating the increase in the weight of the gas supply piping per unit length (10 cm) versus log (P/L) when the gas supply piping was used continuously for a period of one month for fabrication of porous glass preforms for optical fibers;

FIG. 4 is a schematic cross-sectional view illustrating another example of gas supply piping; and

FIG. 5 is a graph indicating results of a study on durability of the gas supply piping.

### DETAILED DESCRIPTION OF THE INVENTION

Hereafter, various embodiments of the apparatus for manufacturing a porous glass preform for an optical fiber of the present invention will be described with reference to the drawings.

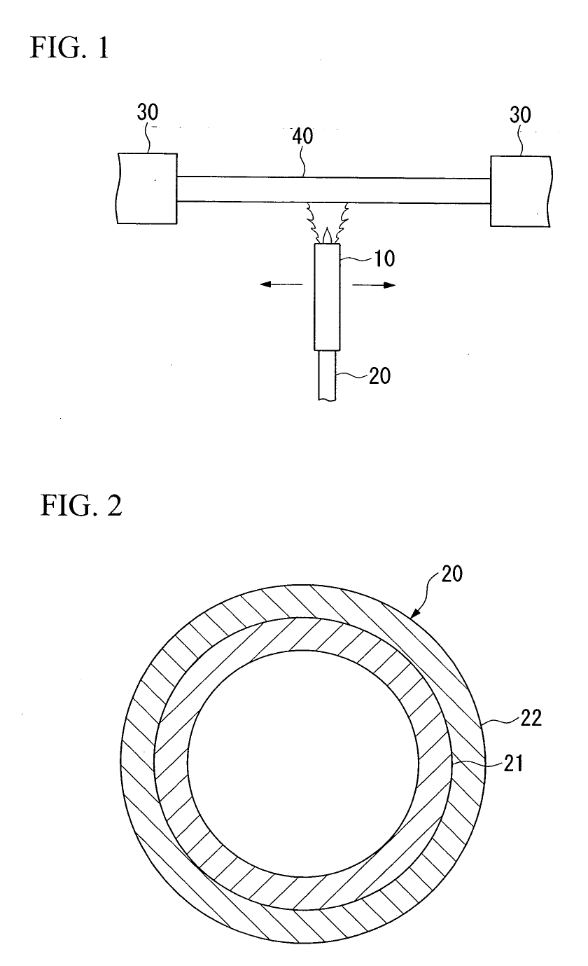

FIG. 1 is a schematic diagram of an apparatus for manufacturing a porous glass preform for an optical fiber by the OVD method as an embodiment of the present invention. FIG. 2 is a schematic cross-sectional view illustrating one example of a piping that connects the gas source to the glass synthesizing burner employed in the apparatus for manufacturing a porous glass preform for an optical fiber of the present invention.

In FIG. 1, reference numeral 10 denotes a glass synthesizing burner, reference numeral 20 denotes a piping that connects the gas source to the glass synthesizing burner (hereinafter referred to as “gas supply piping”), reference numeral 40 denotes a core preform, and reference numerals 30 denote chucks for securing the core preform so as to be rotatable about the longitudinal axis thereof.

In the apparatus for manufacturing a porous glass preform for an optical fiber in this embodiment, both ends of the cylindrical core preform 40 are secured by the chucks 30 so as to being rotatable about the axis thereof. The glass synthesizing burner 10 is arranged so that it can be shifted in the longitudinal direction of the core preform 40. The glass synthesizing burner 10 is connected to the gas supply piping 20 for supplying silicon tetrachloride as a glass forming gas from a gas source (not shown), such as a baking tank, or bubbling by means of carrier gas, or the like.

Furthermore, the glass synthesizing burner 10 includes a mechanism that can shift the glass synthesizing burner 10 back and forth in the longitudinal direction of the core preform 40. Thus, by configuring the glass synthesizing burner 10 to be movable back and forth in the longitudinal direction of the core preform 40, glass particles jetted from the glass synthesizing burner 10 can be deposited evenly around the outer periphery of the core preform 40.

The glass synthesizing burner 10 includes, for example, an oxyhydrogen flame burner that is supplied with silicon tetrachloride, for depositing silica particles generated in flame hydrolysis of silicon tetrachloride around the core preform 40 to form a porous glass preform for an optical fiber.

The gas supply piping 20 includes at least one layer made of flexible synthetic resin, and the ratio of a moisture permeability coefficient (P) (g·cm/cm²·s·cmHg) of the gas supply piping 20 to a thickness L of the gas supply piping (cm) (P/L) is less than 1.0×10⁻¹⁰. If the ratio of the moisture permeability coefficient of the gas supply piping 20 to the thickness of the gas supply piping (P/L) exceeds 1.0×10⁻¹⁰, moisture in the air permeates inside the piping, and the permeated moisture reacts to silicon tetrachloride in the glass forming gas to generate silicon dioxide. As a result, the hardening of the gas supply piping 20 progresses easily.

The flexible synthetic resin of which the gas supply piping 20 is at least one member selected from the group consisting of Nylon 11, Nylon 12, polyurethane, polyvinyl chloride, and fluorine resins.

Since these synthetic resins have excellent mechanical strength in addition to flexibility, the damage to the piping, such as breakage, can be prevented when a glass synthesizing burner is shifted in the longitudinal direction of the core preform.

As used herein, the moisture permeability coefficient P (g·cm/cm²·s·cmHg) of a given material is an indicator that indicates how easily moisture permeates to that material. Therefore, the ratio of the moisture permeability coefficient to the thickness (P/L) of the piping indicates how easily moisture permeates to a given surface of the piping that has a thickness L, and moisture permeates less easily as the thickness L increases.

For example, the moisture permeability coefficient P of polytetrafluoroethylene that has been conventionally used for gas supply piping is 1.0×10⁻¹¹ g·cm/cm²·s·cmHg, and when the thickness L of a piping made of polytetrafluoroethylene is 0.1 cm, the ratio of the moisture permeability coefficient to the thickness (P/L) of the piping is 1.0×10⁻¹⁰ g/cm²·s·cmHg.

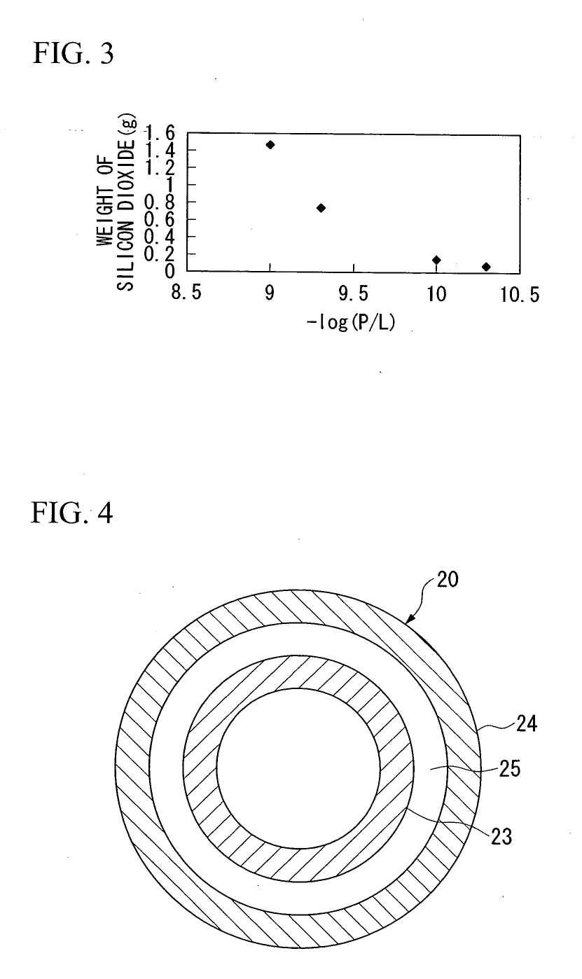

Here, FIG. 3 indicates the increase in the weight of the gas supply piping per unit length (10 cm) versus log (P/L) when the gas supply piping was used continuously for a period of one month for fabrication of porous glass preforms for optical fibers.

In the graph of FIG. 3, an increase in the weight of the gas supply piping equals the weight of silicon dioxide generated within gas supply piping. As shown in FIG. 3, if the ratio of the moisture permeability coefficient to the thickness (P/L) exceeds 1.0×10⁻¹⁰ g/cm²·s·cmHg, the amount of silicon dioxide generated within gas supply piping significantly increases. When a gas supply piping made of polytefrafluoroethylene having a thickness of 0.1 cm was used in which the ratio of the moisture permeability coefficient to the thickness (P/L) was 1.0×10⁻¹⁰ g/cm²·s·cmHg, cracking occurred at about 18 months. This means that if the ratio of a moisture permeability coefficient of the piping to a thickness of the piping (P/L) is 1.0×10⁻¹⁰ g/cm²·s·cmHg or higher, cracking occurs earlier, moisture in the air permeates inside the gas supply piping that connects the gas source to the glass synthesizing burner, and the permeated moisture reacts with silicon tetrachloride, i.e., the glass forming gas, to generate silicon dioxide. As a result, hardening of the gas supply piping is likely to occur.

In the present invention, it is possible to provide the gas supply piping 20 with a structure that is less subject to the permeation of moisture by using a material having a smaller moisture permeability coefficient P, and/or by increasing the thickness L, and/or by supplying dry inert gas in the gap between an inner piping and an outer piping in a dual-tube structure. By constructing a gas supply piping 20 having such a structure, permeation of moisture in the air into the gas supply piping 20 and generation of silicon dioxide by a reaction between the moisture and silicon tetrachloride are inhibited. By inhibiting the generation of silicon dioxide within the gas supply piping 20, the hardening of the gas supply piping 20 is delayed and the lifetime of the gas supply piping 20 can be extended.

For example, when comparing a gas supply piping made of polytetrafluoroethylene and a gas supply piping that is made of a material having a moisture permeability coefficient of one third of that of polytetrafluoroethylene having the same thickness, the lifetime of the latter is three times longer than the former.

The method for controlling the ratio of the moisture permeability coefficient to the thickness (P/L) of the gas supply piping 20 less than 1.0×10⁻¹⁰ g/cm²·s·cmHg includes the following:
(1) Using the gas supply piping 20 that has a multi-layered structure including at least one layer made of a material having a small moisture permeability coefficient.
(2) Increasing the thickness of the gas supply piping 20.
(3) Constructing the gas supply piping 20 that includes an inner piping for supplying the glass forming gas and an outer piping that is provided around an outer periphery of the inner piping while being spaced by a gap, and supplying dry inert gas in the gap.

As an example of the gas supply piping 20 that has a multi-layered structure including at least one layer made of a material having a small moisture permeability coefficient, the structure shown in FIG. 2 is illustrated.

The gas supply piping 20 includes an inner layer 21 and an outer layer 22 disposed at the outer periphery of the inner layer 21. In the gas supply piping 20, at least one of the inner layer 21 and the outer layer 22 is made of a material having a small moisture permeability coefficient.

For example, in the gas supply piping 20, the inner layer 21 may be made of a synthetic resin and the outer layer 22 may be made of a material having a small moisture permeability coefficient.

It should be noted that although the two-layered structure including the inner layer 21 and the outer layer 22 is illustrated as the gas supply piping 20 in FIG. 2, the present invention is not limited to this structure. The gas supply piping may have a structure with three or more layers including at least one layer made of a material having a small moisture permeability coefficient.

As long as the gas supply piping 20 has a multi-layered structure including at least one layer made of a material having a small moisture permeability coefficient, permeation of moisture in the air into the gas supply piping 20 can be reduced.

As a material having a small moisture permeability coefficient, metals having a moisture permeability coefficient of about zero is preferably used. Examples of such a metal include stainless steel, aluminum, copper, nickel, iron, and among them stainless steel or aluminum is more preferable in an application in which silicon tetrachloride (i.e., the glass forming gas) that exhibits an oxidation action is supplied from the gas source to the glass synthesizing burner since stainless steel and aluminum have resistance to acid. By using a metal with a moisture permeability coefficient of about zero as the material of the gas supply piping 20, the thickness of the gas supply piping 20 can be reduced and the flexible gas supply piping 20 may be manufactured. In addition, metals are preferable as the material of the gas supply piping 20 since they exhibit heat resistance.

In addition, since stainless steel or aluminum has an excellent thermal conductivity, the efficiency of the heating of the piping for the purpose of controlling the temperature of the glass forming gas can be enhanced.

A specific example of the gas supply piping 20 is the gas supply piping having the inner layer 21 made of polytetrafluoroethylene and the outer layer 22 made of stainless steel. For example, in a gas supply piping 20 having such a structure with the inner layer 21 having a thickness between 0.3 mm and 2.0 mm, if the outer layer 22 has a thickness between 0.01 mm and 0.20 mm, the gas supply piping 20 has a moisture permeability coefficient of about zero and has a sufficient flexibility and acid-resistance.

By constructing a gas supply piping 20 with such a structure, since polytetrafluoroethylene is not exposed to the air outside of the gas supply piping 20, polytetrafluoroethylene is less subject to permeation of water. Thus, the hardening of the piping and deterioration of flexibility of the piping can be prevented. If the gas supply piping were made of only a metal, the gas supply piping would be less flexible. In contrast, by providing the inner layer 21 made of polytetrafluoroethylene, the gas supply piping 20 has an excellent flexibility. In addition, if the inner layer were made of a metal, it would be possible for the inner layer to be corroded by the glass forming gas.

An alternative structure of the gas supply piping is shown in FIG. 4, wherein an inner piping for supplying the glass forming gas and an outer piping that is provided around an outer periphery of the inner piping are spaced by a gap, and dry inert gas is supplied through this gap.

The gas supply piping 20 has a so-called dual tube structure as shown in FIG. 4 that includes an inner piping 23 that functions as the gas supply piping and an outer piping 24. By supplying gas to the gap 25 defined between the inner piping and the outer piping 24, the moisture permeated from the outer piping 24 to the gap 25 is prevented from permeating to the inner piping 23.

Furthermore, the gas supply piping 20 may be covered by a heater and a thermal insulating material. Examples of the heater include a nickel-chrome wire heater and iron-chrome wire heater. Examples of the thermal insulating material includes silicone resins and urethanes.

Next, a method for manufacturing a porous glass preform for an optical fiber using the apparatus for manufacturing a porous glass preform for an optical fiber of this embodiment will be explained.

First, both ends of the core preform 40 are secured by the chucks 30, and the core preform 40 is rotated about the axis thereof. Then, silicon tetrachloride is supplied from the gas source (not shown) to the glass synthesizing burner 10 via the gas supply piping 20 while shifting the glass synthesizing burner 10 back and forth in the longitudinal direction of the core preform 40. In the process, silicon dioxide is synthesized by a hydrolysis or oxidation reaction of silicon tetrachloride that occurs in a flame from the glass synthesizing burner 10, and the resultant silicon dioxide is deposited evenly around the outer periphery of the core preform 40 to form a porous glass preform for an optical fiber.

### EXAMPLES

The following provides a description of specific Examples. However, although the invention will be explained below in more detail by reference to the following Examples, the invention should not be construed as being limited to the following Examples only. It is to be expressly understood, that the Examples are for purpose of illustration only and are not intended as a definition of the limits of the invention.

### Example 1

A porous glass preform for an optical fiber was fabricated using the apparatus for manufacturing a porous glass preform for an optical fiber as shown in FIG. 1.

In Example 1, the gas supply piping 20 for supplying silicon tetrachloride, i.e., the glass forming gas, from the gas source to the glass synthesizing burner 10 has a two-layered structure in which an inner layer was made of polytetrafluoroethylene (moisture permeability coefficient P of 1.0×10⁻¹¹ g·cm/cm²·s·cmHg) and an outer layer was made by plating stainless steel (moisture permeability coefficient P is about zero) on the inner layer. The outer diameter of the gas supply piping 20 was 0.61 cm, the thickness of the inner layer was 0.1 cm, and the thickness of the outer layer was 0.005 cm. The ratio of the moisture permeability coefficient to the thickness (P/L) of the gas supply piping 20 was about zero.

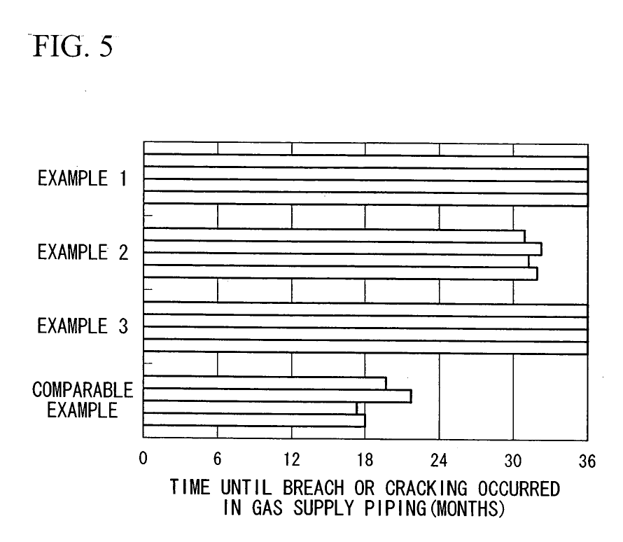

Porous glass preforms for an optical fiber were fabricated using the gas supply piping 20 every day for 20 hours a day, and the time until a breach or cracking occurred in the gas supply piping 20 was measured. The measurement was conducted for four of the gas supply piping 20 having the same structure. The results are shown in FIG. 5.

### Example 2

A porous glass preform for an optical fiber was fabricated using the apparatus for manufacturing a porous glass preform for an optical fiber as shown in FIG. 1.

In Example 2, the gas supply piping 20 has a single-layered structure that is made of polytetrafluoroethylene (moisture permeability coefficient P of 1.0×10⁻¹¹ g·cm/cm²·s·cmHg) and has an outer diameter of 0.6 cm and a thickness of 0.2 cm. The ratio of the moisture permeability coefficient to the thickness (P/L) of the gas supply piping 20 was 0.5×10⁻¹¹ g/cm²·s·cmHg.

Porous glass preforms for an optical fiber were fabricated using the gas supply piping 20 every day for 20 hours a day, and the time until a breach or cracking occurred in the gas supply piping 20 was measured. The measurement was conducted for four of the gas supply piping 20 having the same structure. The results are shown in FIG. 5.

### Example 3

A porous glass preform for an optical fiber was fabricated using the apparatus for manufacturing a porous glass preform for an optical fiber as shown in FIG. 1.

In Example 3, as the gas supply piping 20, a dual piping was used that included inner piping 23 made of polytetrafluoroethylene and outer piping 24 made of polytetrafluoroethylene that was provided at the outer periphery thereof spaced by the gap 25 as shown in FIG. 4. The inner piping 23 had an outer diameter of 0.6 cm and a thickness of 0.1 cm, and the outer piping 24 had an outer diameter of 1.0 cm and a thickness of 0.1 cm.

Porous glass preforms for an optical fiber were fabricated using the gas supply piping 20 every day for 20 hours a day while supplying nitrogen (dew point −80° C.) to the gas between the inner piping 23 and the outer piping 24 at a flow rate of 3 liters/min, and the time until a breach or cracking occurred in the gas supply piping 20 was measured. The measurement was conducted for four of the gas supply piping 20 having the same structure. The results are shown in FIG. 5.

### Comparative Example

A porous glass preform for an optical fiber was fabricated using the apparatus for manufacturing a porous glass preform for an optical fiber as shown in FIG. 1.

In this Comparative Example, the gas supply piping 20 had a single-layered structure that is made of polytetrafluoroethylene (moisture permeability coefficient P of 1.0×10⁻¹¹ g·cm/cm²·s·cmHg) and had an outer diameter of 0.6 cm and a thickness of 0.1 cm. The ratio of the moisture permeability coefficient to the thickness (P/L) of the gas supply piping 20 was 1.0×10⁻¹⁰ g/cm²·s·cmHg.

Porous glass preforms for an optical fiber were fabricated using the gas supply piping 20 every day for 20 hours a day, and the time until a breach or cracking occurred in the gas supply piping 20 was measured. The measurement was conducted for four of the gas supply piping 20 having the same structure. The results are shown in FIG. 5.

The results in FIG. 5 indicate that no breach or cracking occurred in the gas supply piping 20 of Examples 1 and 3 after 36 months.

Breaches or cracking occurred in the gas supply piping 20 of Example 2 after 30 months.

Breaches or cracking occurred in the gas supply piping 20 of the Comparative Example after about 20 months.

It is believed that the reason the gas supply piping 20 of Example 2 had a lifetime almost two times longer than the gas supply piping 20 of the Comparative Example is that the ratio of the moisture permeability coefficient to the thickness (P/L) of the gas supply piping 20 of Example 2 was one half of the ratio in the Comparative Example.

The apparatus for manufacturing a porous glass preform for an optical fiber of the present invention may be applicable to various cases in which permeation of moisture within piping is require to be reduced.

While preferred embodiments of the invention have been described and illustrated above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. An apparatus for manufacturing a porous glass preform for an optical fiber, comprising:
a glass synthesizing burner;
a gas source for supplying a glass forming gas to the glass synthesizing burner; and
a piping for connecting the gas source to the glass synthesizing burner, wherein the piping comprises at least one layer made of flexible synthetic resin,
wherein a ratio of a moisture permeability coefficient P (g·cm/cm²·s·cmHg) of the piping to a thickness L of the piping (cm) (P/L) is less than 1.0×10⁻¹⁰g/cm²·s·cmHg.

2. The apparatus for manufacturing a porous glass preform for an optical fiber according to claim 1, wherein the piping comprises at least two layers, and at least one layer of the at least two layers is made of one of stainless steel or aluminum.

3. The apparatus for manufacturing a porous glass preform for an optical fiber according to claim 1, wherein the piping comprises an inner piping for supplying the glass forming gas and an outer piping that is provided around an outer periphery of the inner piping while being spaced therefrom by a gap, and a dry gas is supplied through the gap.

4. The apparatus for manufacturing a porous glass preform for an optical fiber according to claim 3, wherein the gas supplied through the gap contains at least one gas selected from the group consisting of nitrogen, argon, and helium.

5. The apparatus for manufacturing a porous glass preform for an optical fiber according to claim 3, wherein the outer piping is made of polytetrafluoroethylene.

6. The apparatus for manufacturing a porous glass preform for an optical fiber according to claim 1, wherein the piping is covered by a heater and a thermal insulating material.

7. The apparatus for manufacturing a porous glass preform for an optical fiber according to claim 1, wherein the synthetic resin is at least one member selected from the group consisting of Nylon 11, Nylon 12, polyurethane, polyvinyl chloride, and fluorine resins.

8. The apparatus for manufacturing a porous glass preform for an optical fiber according to claim 1, wherein the piping comprises an inner layer and an outer layer.

9. The apparatus for manufacturing a porous glass preform for an optical fiber according to claim 8, wherein the inner layer is made of a synthetic resin and the outer layer is made of a material having a moisture permeability coefficient P of about zero.

10. The apparatus for manufacturing a porous glass preform for an optical fiber according to claim 9, wherein the outer layer is made of material having a moisture permeability coefficient P of about zero is one member selected from the group consisting of stainless steel, aluminum, copper, nickel, and iron.

11. The apparatus for manufacturing a porous glass preform for an optical fiber according to claim 9, wherein the inner layer is made of polytetrafluoroethylene and the outer layer is made of stainless steel.

12. The apparatus for manufacturing a porous glass preform for an optical fiber according to claim 9, wherein the inner layer has a thickness between 0.3 mm and 2.0 mm and the outer layer has a thickness of between 0.01 mm and 0.20 mm.

13. The apparatus for manufacturing a porous glass preform for an optical fiber according to claim 1, wherein the glass forming gas is silicon tetrachloride.

14. The apparatus for manufacturing a porous glass preform for an optical fiber according to claim 1, further comprising a plurality of chucks, wherein the chucks secure a cylindrical core preform, and the cylindrical core preform is rotated.

15. The apparatus for manufacturing a porous glass preform for an optical fiber according to claim 1, wherein the glass synthesizing burner is capable of being shifted in a longitudinal direction.

16. The apparatus for manufacturing a porous glass preform for an optical fiber according to claim 1, wherein the glass synthesizing burner includes a mechanism that can shift the burner in a longitudinal direction.

17. The apparatus for manufacturing a porous glass preform for an optical fiber according to claim 1, wherein the glass synthesizing burner is an oxyhydrogen flame burner.
